(19) United States
(12) Patent Application Publication
(10) Pub. No.: US 2026/0057480 A1
(43) Pub. Date: Feb. 26, 2026

(54) SECURE IMAGING FOR CONTENT PROVENANCE AND AUTHENTICITY

(71) Applicant: QUALCOMM Incorporated, San Diego, CA (US)

(72) Inventor: Shalaj JAIN, San Diego, CA (US)

(21) Appl. No.: 18/814,366

(22) Filed: Aug. 23, 2024

(51) Int. Cl. G06T 5/20; G06T 5/70

(52) U.S. Cl. CPC G06T 5/20; G06T 5/70; G06T 2207/20208

(57) ABSTRACT

Systems and techniques are described for media security. For example, a computing device can capture, by a camera of a device in a secure mode, a first image of a scene. The computing device can capture, by the camera in a non-secure mode, a second image of the scene. The computing device can generate, within a secure environment of the device based on the first image, a first manifest associated with the first image. The computing device can process, within a non-secure environment of the device, the second image to produce a processed second image. The computing device can generate, within the secure environment based on the processed second image, a second manifest associated with the processed second image. The computing device can generate a media asset that comprises the first manifest, the second manifest, and the processed second image.

### FIELD

The present disclosure generally relates to media security. For example, aspects of the present disclosure relate to secure imaging for content provenance and authenticity.

### BACKGROUND

Currently, there are technical standards, such as standards proposed by content provenance and authenticity (C2PA), that have been developed to address the widespread occurrence of misleading information online by certifying the source and history (or provenance) of media content, which may be in the form of an image or photograph (e.g., a snapshot), video, audio, or text file. These standards focus on systems that provide context and history for digital media to tackle disinformation in the digital ecosystem. For example, these standards typically employ a set of additional data (metadata) containing details about the provenance of information displayed or played on a digital device.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for providing secure imaging for content provenance and authenticity. In some aspects, an apparatus for providing trust for assets is provided. The apparatus includes: at least one memory; and at least one processor coupled to the at least one memory and configured to: obtain, from a camera of a device in a secure mode, a first image of a scene; obtain, from the camera of the device in a non-secure mode, a second image of the scene; generate, within a secure environment of the device based on the first image, a first manifest associated with the first image; process, within a non-secure environment of the device, the second image to produce a processed second image; generate, within the secure environment based on the processed second image, a second manifest associated with the processed second image; and generate a media asset that includes the first manifest, the second manifest, and the processed second image.

In some aspects, a method for providing trust for assets is provided. The method includes: capturing, by a camera of a device in a secure mode, a first image of a scene; capturing, by the camera of the device in a non-secure mode, a second image of the scene; generating, within a secure environment of the device based on the first image, a first manifest associated with the first image; processing, within a non-secure environment of the device, the second image to produce a processed second image; generating, within the secure environment based on the processed second image, a second manifest associated with the processed second image; and generating a media asset that includes the first manifest, the second manifest, and the processed second image.

In some aspects, a non-transitory computer-readable medium is provided having stored thereon instructions that, when executed by at least one processor, cause the at least one processor to: obtain, from a camera of a device in a secure mode, a first image of a scene; obtain, from the camera of the device in a non-secure mode, a second image of the scene; generate, within a secure environment of the device based on the first image, a first manifest associated with the first image; process, within a non-secure environment of the device, the second image to produce a processed second image; generate, within the secure environment based on the processed second image, a second manifest associated with the processed second image; and generate a media asset that includes the first manifest, the second manifest, and the processed second image.

In some aspects, an apparatus for providing trust for assets is provided. The apparatus includes: means for capturing, in a secure mode, a first image of a scene; means for capturing, in a non-secure mode, a second image of the scene; means for generating, within a secure environment of the device based on the first image, a first manifest associated with the first image; means for processing, within a non-secure environment of the device, the second image to produce a processed second image; means for generating, within the secure environment based on the processed second image, a second manifest associated with the processed second image; and means for generating a media asset that includes the first manifest, the second manifest, and the processed second image.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example computing system including a function module, in accordance with some aspects of the disclosure.

FIG. 2 is a diagram illustrating examples of elements of a content provenance and authenticity (C2PA) architecture, in accordance with some aspects of the disclosure.

FIG. 3 is a diagram illustrating an example of a manifest including constituent parts, in accordance with some aspects of the disclosure.

FIG. 4 is a diagram illustrating a visual representation of an asset, in the form of an image, containing a single claim with multiple assertions that have been embedded inside of the image, in accordance with some aspects of the disclosure.

FIG. 5 is a block diagram illustrating an example of a trust model for establishing trust, in accordance with some aspects of the disclosure.

FIG. 6 is a functional block diagram illustrating an example of a process for establishing trust based on a signer's credentials, in accordance with some aspects of the disclosure.

FIG. 7 is a diagram illustrating an example of a process for a first solution for providing higher level trust and assurances to the assertions regarding an asset, in accordance with some aspects of the disclosure.

FIG. 8 is a diagram illustrating an example of a process for a second solution for providing higher level trust and assurances to the assertions regarding an asset, in accordance with some aspects of the disclosure.

FIG. 9 is a diagram illustrating an example of a process for a third solution for providing higher level trust and assurances to the assertions regarding an asset, in accordance with some aspects of the disclosure.

FIG. 10 is a diagram illustrating examples of elements of a C2PA architecture, showing examples of two created manifests, in accordance with some aspects of the disclosure.

FIG. 11 is a flow diagram illustrating an example of a process for providing trust for an asset, in accordance with some aspects of the disclosure.

FIG. 12 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, certain technical standards (e.g., standards for content provenance and authenticity, such as C2PA standards) have been developed to address the prevalence of misleading information online by certifying the source and history (or provenance) of media content, such as a photo (e.g., a snapshot), video, audio, text file, etc. Such standards focus on systems that provide context and history for digital media to tackle disinformation in the digital ecosystem.

For example, the above-noted standards may employ a set of additional data (referred to as metadata) containing details about the provenance of information displayed or played on a digital device. Provenance empowers content creators and editors, regardless of their geographic location or degree of access to technology, to disclose information about who created or changed an asset, what was changed, and how it was changed. Content with provenance provides indicators of authenticity such that consumers can have awareness of who has altered the content and what exactly has been changed to the content. This ability to provide provenance for creators, publishers, and consumers is essential to facilitating trust online.

Mobile devices (e.g., smart phones) capture an estimated ninety (90) percent (%) of all digital photos globally. With the fast adoption of powerful content creation and editing technologies (e.g., generative artificial intelligence (AI) tools), there is a need to enable transparency (e.g., to enable the distinction between authentic and synthetic media). Many companies are heavily investing in on-device generative-AI. For instance, smart phones may soon become the most used AI generative platforms. Such companies are generally promoting responsible usage of such capabilities such that neither synthetic (e.g., AI generated) content should be promoted as “real” (or original) content, nor real content should be presented as AI generated content. Currently, media created on a C2PA capable smartphone may be verified on any C2PA compliant website, platform, phone, or browser.

However, anyone can implement the C2PA specification (or other specification defined by a standard for content provenance and authenticity) and make a claim of assertions about the provenance of a media asset. A media asset can include an item of media content, such as an image, a video, audio, a text file, etc. As such, improved systems and techniques that provide higher levels of trust and assurances to the assertions regarding a media asset can be beneficial.

In one or more aspects, systems, apparatuses, processes (also referred to as methods), and computer-readable media (collectively referred to herein as “systems and techniques”) are described herein for providing secure imaging for content provenance and authenticity. In some cases, the secure imaging can be used as a baseline for a standard for content provenance and authenticity (e.g., a C2PA secure snapshot baseline). In one or more examples, the systems and techniques provide a secure baseline approach that allows for minimum disruption to a normal camera snapshot pipeline, while still achieving the desired security level by establishing a first manifest (e.g., an origin manifest) with a higher assurance claim provided by a trusted executed environment (TEE). A manifest is a verifiable unit that can include assertions, claims, credentials, and signatures, which are bound together into the manifest. A set of manifests, which is stored in a manifest store, represents provenance data for an asset. For example, on a system on a chip (SOC), it can be assured that every image captured came from hardware (HW) controlled by a TEE of the SOC. The secure baseline approach also allows for key performance indicators (KPIs) of a snapshot for the user experience to be the same, while the background works on establishing the provenance for a secure image.

C2PA is similar to blockchain in that manifests (e.g., including assertions) are linked together cryptographically. The C2PA specification indicates how to determine an original source of an image from a final source for the image. The systems and techniques involve determining whether source information of a media asset (e.g., an image) can be trusted and how to establish a higher trust with a differentiating factor.

In one or more aspects, during operation of the systems and techniques for providing trust for an asset, a camera of a device can operate in a secure mode. The secure mode of operation can include capturing an image that is accessible by a secure environment (e.g., a TEE). For example, while operating in the secure mode, the camera can capture a image of a scene. The camera of the device can operate in a non-secure (NS) mode. The NS mode of operation can include capturing an image (e.g., captured at the same time as the image captured in the secure mode) that is accessible by a non-secure environment (e.g., an operating system, such as a high-level operating system (HLOS)). For example, in the NS mode, the camera can capture a second image of the scene. One or more processors can generate, within a secure environment of the device based on the first image, a first manifest associated with the first image. One or more processors can process, within the non-secure environment of the device, the second image to produce a processed second image. One or more processors can generate, within the secure environment based on the processed second image, a second manifest associated with the processed second image. One or more processors can generate a media asset that includes the first manifest, the second manifest, and the processed second image. For example, the one or more processors can associate the first manifest with the second manifest for the asset such that the asset comprises the first manifest, the second manifest, and the processed second image.

In one or more examples, the first manifest can include a plurality of first assertions associated with the first image. In some examples, the plurality of first assertions can include a type of camera used to capture the first image, a location of where the first image was captured, and/or a time and day that the first image was captured. In one or more examples, the second manifest can include a plurality of second assertions associated with the processed second image. In some examples, the plurality of second assertions can include a type of editing used to process the second image to produce the processed second image and/or a time and day that the second image was processed to produce the processed second image.

In one or more examples, the type of editing can include filtering, denoising, compression, or high dynamic range (HDR). In some examples, the first image and the second image can be simultaneously captured. In one or more examples, the secure environment can include a trusted virtual machine (TVM) and/or a trusted execution environment (TEE). In some examples, the non-secure environment can include a high-level operating system (HLOS) virtual machine (VM). In one or more examples, the device can be a smartphone, a smart watch, or a tablet computer. In some examples, the asset can be in the form of an image.

Various aspects of the systems and techniques described herein will be discussed below with respect to the figures.

The systems and techniques described herein may be implemented by any type of system or device. One illustrative example of a system that can be used to implement the systems and techniques described herein is a computing device, or a system or component of the computing device.

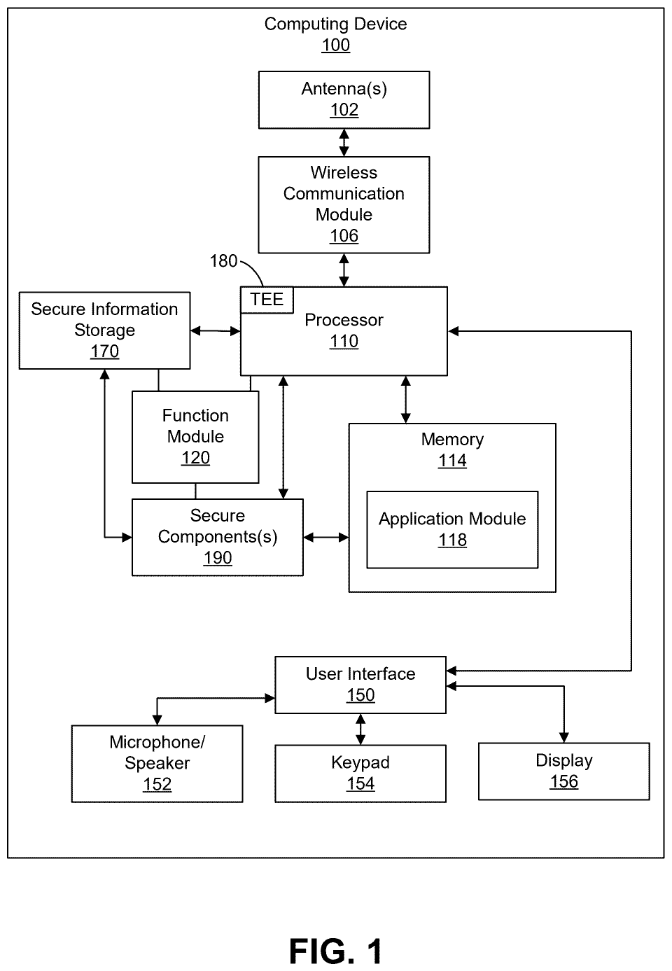

According to various examples, FIG. 1 is a diagram illustrating an example computing device 100 that may implement the systems and techniques described herein. The computing device 100 may include, but is not limited to, any of the following: one or more processors (e.g., components that include integrated circuitry, memory, input and output device(s) (not shown), non-volatile storage hardware, one or more physical interfaces, any number of other hardware components (not shown), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IOT) device, a server (e.g., a blade-server in a blade-server chassis, a rack server in a rack, etc.), a desktop computer, a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a network-connected watch or smartwatch, or other wearable device), a robotic device, a smart television, a smart appliance, an extended reality (XR) device (e.g., augmented reality (AR), virtual reality (VR), etc.), any device that includes one or more System on Chips (SoCs), and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

As illustrated, the computing device 100 may include one or more antennas 102, one or more wireless communication modules 106, a processor 110, memory 114, application module 118, a function module 120, user interface 150, microphone/speaker 152, keypad 154, display 156, secure information storage 170, trusted execution environment 180, and secure components 190.

As shown, the computing device 100 may include one or more wireless communication modules 106 that may be connected to one or more antennas 102. The one or more wireless communication modules 106 comprise suitable devices, circuits, hardware, and/or software for communicating with and/or detecting signals to/from an access point, a network, a base station, and/or directly with other wireless devices within a network.

In some implementations, the one or more wireless communication modules 106 may comprise a CDMA communication system suitable for communicating with a CDMA network of wireless base stations. In some implementations, the wireless communication system may comprise other types of cellular telephony networks, such as, for example, TDMA, GSM, WCDMA, LTE, NR, and the like. Additionally, any other type of wireless networking technologies may be used, including, for example, WiMax (802.16), Wi-Fi (802.11), and the like.

The processor(s) (also referred to as a controller) 110 may be connected to the one or more wireless communication modules 106. The processor 110 may include one or more microprocessors, microcontrollers, and/or digital signal processors that provide processing functions, as well as other calculation and control functionality. The processor 110 may be coupled to storage media (e.g., memory) 114 for storing data and software instructions for executing programmed functionality within the mobile device. The memory 114 may be on-board the processor 110 (e.g., within the same IC package), and/or the memory may be external memory to the processor and functionally coupled over a data bus.

A number of software engines and data tables may reside in memory 114 and may be utilized by the processor 110 in order to manage communications, perform positioning determination functionality, and/or perform device control functionality. In some cases, the memory 114 may include an application module 118. It is to be noted that the functionality of the modules and/or data structures may be combined, separated, and/or be structured in different ways depending upon the implementation of the computing device 100.

The application module 118 may include a process running on the processor 110 of the computing device 100, which may request data from one of the other modules of the computing device 100. Applications typically run within an upper layer of the software architectures and may be implemented in a rich execution environment of the computing device 100, and may include indoor navigation applications, shopping applications, financial services applications, social media applications, location aware service applications, etc.

As illustrated, the computing device 100 can include a function module 120. In some cases, the function module 120 can be incorporated with and/or in communication with one or more of the processor 110, secure information storage 170, trusted execution environment 180, or secure components 190. In some cases, the function module 120 can be configured to generate one or more manifests associated with media content (e.g., one or more images), as described herein.

In FIG. 1, in some examples, the computing device 100 includes the secure information storage 170. In some examples, the secure information storage 170 can be any storage device configured to store security information assets (e.g., cryptographic keys, metadata, etc.). For instance, the secure information storage 170 is where security information assets are stored and initially obtained from when needed for use on a computing device (e.g., for encryption and/or decryption of data). In some cases, the secure information storage 170 can include a key store or a key table. Examples of secure information storage 170 include, but are not limited to, various types of read-only memory, one-time programmable memory devices (e.g., one time programmable fuses or other types of one time programmable memory devices), non-volatile memory, etc. The secure information storage 170 may be operatively connected to the trusted execution environment 180 and/or the secure components 190. Although FIG. 1 shows the computing device 100 as including a single secure information storage 170, the computing device 100 may include any number of secure information storages without departing from the scope of examples described herein.

The processor 110 may include a trusted execution environment (TEE) 180. The trusted execution environment 180 may also be referred to as a trusted management environment, trust zones, trusted platform modules, or the like. The trusted execution environment 180 can be implemented as a secure area of the processor 110 that can be used to process and store sensitive data in an environment that is segregated from the rich execution environment in which the operating system and/or applications (such as those of the application module 118) may be executed. The trusted execution environment 180 can be configured to execute secure applications (also referred to as trusted applications) that provide end-to-end security for sensitive data by enforcing confidentiality, integrity, and protection of the sensitive data stored therein. The trusted execution environment 180 can be used to store encryption keys, access tokens, and other sensitive data.

The computing device 100 may include one or more secure components 190. In some cases, the secure components 190 can be referred to as trusted components, secure elements, trusted elements, or the like. The computing device 100 may include the secure components 190 in addition to or instead of the trusted execution environment 180. The secure components 190 can comprise autonomous and tamper-resistant hardware that can be used to execute secure applications and the confidential data associated with such applications. The secure components 190 can be used to store encryption keys, access tokens, and other sensitive data. The secure components 190 can comprise a Near Field Communication (NFC) tag, a Subscriber Identity Module (SIM) card, or other type of hardware device that can be used to securely store data. The secure components 190 can be integrated with the hardware of the computing device 100 in a permanent or semi-permanent fashion or may, in some implementations, be a removable component of the computing device 100 that can be used to securely store data and/or provide a secure execution environment for applications.

Examples of secure applications that may be performed by the computing device 100, processor 110, secure information storage 170, trusted execution environment 180, secure components 190, and/or any combination thereof include, but are not limited to, encrypting data, decrypting data, key derivation, performing data integrity verification, and performing authenticated encryption and decryption. In some examples, the computing device 100 and/or portions thereof can be configured to perform the various cryptographic service types by being configured to execute one or more cryptographic algorithms. As an example, to perform encryption and decryption, one or more components (e.g., secure information storage 170, trusted execution environment 180, secure components 190) of the computing device 100 may be configured to execute one or more of the Advanced Encryption Standard XOR-encrypt-XOR Tweakable Block Ciphertext Stealing (AES-XTS) algorithm, the AES-Cipher Block Chaining (AES-CBC) algorithm, the AES-Electronic Codebook (AES-EBC) algorithm, the Encrypted Salt-Sector Initialization Vector-AES-CBC (ESSIV-AES-CBC) algorithm, etc., including any variants of such algorithms (e.g., 128 bits, 192 bits, 256 bits, etc.). As another example, to perform integrity verification, one or more components of the computing device 100 may be configured to execute a hash algorithm such as, for example, the one or more members of the SHA family of hash algorithms. As another example, to perform authenticated encryption, one or more components of the computing device 100 may be configured to perform a digital signature scheme algorithm (e.g., such as for the Dilithium signature scheme, the Racoon signature scheme, and the PROV signature scheme). In some aspects, one or more components of the computing device 100 may be configured to execute any other cryptographic algorithms without departing from the scope of examples described herein.

The computing device 100 may further include a user interface 150 providing suitable interface systems, such as a microphone/speaker 152, a keypad 154, and/or a display 156 that allows user interaction with the computing device 100. The microphone/speaker 152 can provide for voice communication services (e.g., using the one or more wireless communication modules 106). The keypad 154 may comprise suitable buttons for user input. The display 156 may include a suitable display, such as, for example, a backlit LCD display, and may further include a touch screen display for additional user input modes.

While FIG. 1 shows a certain number of components in a particular configuration, one of ordinary skill in the art will appreciate that the computing device 100 may include more components or fewer components, and/or components arranged in any number of alternate configurations without departing from the scope of examples described herein. Additionally, although not shown in FIG. 1, one of ordinary skill in the art will appreciate that the computing device 100 may execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 1. The components shown in FIG. 1 may or may not be discrete components. In some aspects, one or more of the components can be combined into different hardware elements, implemented in software, and/or otherwise implemented using software and/or hardware. As used herein, the term device may be a discrete component or apparatus, or may not be a discrete component. In some aspects, other devices can exist within, be part of, and/or utilize the same hardware components as a device.

As previously mentioned, media created on a computing device (e.g., a mobile phone) enabled for implementing a standard for content provenance and authenticity (e.g., a C2PA-capable mobile phone) may be verified on any entity that is compliant with the standard (e.g., a C2PA compliant website, platform, phone, or browser). C2PA will be used herein as an illustrative example of a standard for content provenance and authenticity. In one or more aspects, content provenance and authenticity information (e.g., C2PA information) includes a series of statements that cover areas, such as asset creation, authorship, edit actions, capture device details, bindings to content and many other subjects. These statements, referred to as assertions, make up the provenance of a given media asset (e.g., an image) and represent a series of trust signals that can be used by a human to improve their view of trustworthiness concerning the asset. Assertions are wrapped up with additional information into a digitally signed entity referred to as a claim. Verifiable credentials of individual actors that are involved in the creation of the assertions can be added to the content provenance and authenticity information to provide additional trust signals to the process of assessing trust worthiness of the asset.

These assertions, claims, credentials, and signatures are all bound together into a verifiable unit, referred to as a manifest, by a hardware or software component, referred to as a claim generator. A set of manifests, which is stored in a manifest store, represents provenance data for an asset.

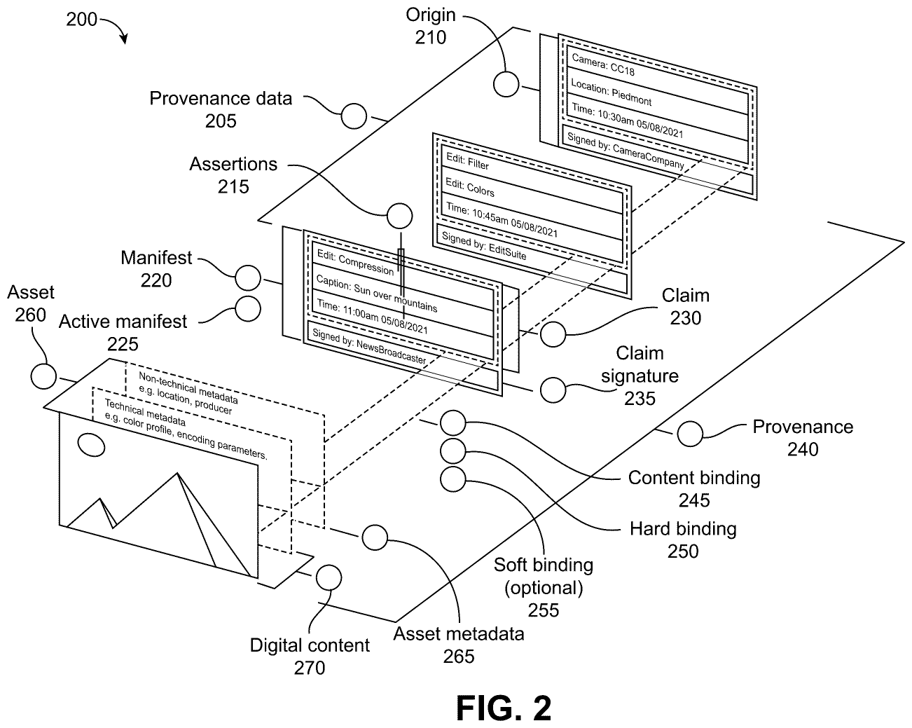

FIG. 2 shows an example of C2PA architecture. In particular, FIG. 2 is a diagram illustrating examples of elements of a C2PA architecture 200. In FIG. 2, the elements of the C2PA architecture 200 are shown to include an asset 260 (e.g., in the form of an image). An asset 260 is a file or stream of data containing digital content 270, asset metadata 265 and, optionally, a manifest 220. The digital content 270 is the portion of an asset 260 that represents the actual content, such as pixels of an image, along with any additional technical metadata required to understand the content (e.g., a color profile and/or encoding parameters). The asset metadata 265 is the portion of the asset 260 that represents the non-technical information about the asset 260 and its digital content 270.

The elements of the C2PA architecture 200 are also shown to include provenance data 205, which includes multiple manifests 220, including an origin 210 and an active manifest 225. A manifest 220 is a set of information about the provenance 240 of the asset 260 based on the combination of one or more assertions 215 (including content bindings 245), a single claim 230, and a claim signature 235. The provenance 240 is the logical concept of understanding the history of an asset 260 and the asset's 260 interaction with actors and other assets, as represented by the provenance data 205.

As shown in FIG. 2, a single manifest 220 includes multiple assertions 215, a claim 230, and a claim signature 235. Manifests 220 can be stored within a manifest store. A manifest store is a collection of manifests 220, and can either be embedded into the asset 260 or be external to the asset 260. An origin 210 (an origin manifest) is the manifest 220 in provenance data 205 that represents the software or device that initially created the asset 260. The active manifest 225 is the last manifest of the manifests 220 in the manifest store that is the manifest 220 with a set of content bindings 245 that are able to be validated.

An assertion 215 is a data structure that represents a statement asserted by an actor concerning the asset 260. The data of an assertion 215 may be within the manifest 220. In one or more examples, the assertion 215 may be associated with how the asset 260 was created (e.g. such as by a camera, by filtering, or by compression), where the asset 260 was created (or captured, in the case of the asset 260 being an image) for example a city location or in terms of latitude and longitude coordinates, when the asset 260 was created (e.g., the specific time and day of creation), how the asset 260 was edited (e.g., by color editing), or the subject matter of the asset 260 (e.g., the asset 260 is an image of the sun over mountains).

The actor may be a human or non-human (hardware or software) that is participating in the C2PA ecosystem. For example, an actor may be a camera (capture device), image editing software, a cloud service, or a person using such tools. A claim 230 is a digitally signed and tamper-evident data structure that references a set of assertions 215 by one or more actors, concerning the asset 260, and the information necessary to represent the content binding 245. The data of a claim 203 may be within the manifest 220. The claim signature 235 is a digital signature on the claim 230 using the private key of an actor. The claim signature 235 may be within the manifest 220.

The authenticity is a property of the digital content 270 including a set of facts (e.g., provenance data 205 and hard bindings 250) that can be cryptographically verified as not having been tampered with. A content binding 250 is information that associates the digital content 270 to a specific manifest 220 associated with a specific asset 260, either as a hard binding 250 or a soft binding 255. A hard binding 250 is one or more cryptographic hashes that uniquely identify either the entire asset 260 or a portion thereof. A soft binding 255 is a content identifier that is either not statistically unique (e.g., a fingerprint) or is embedded as a watermark in the identified digital content 270.

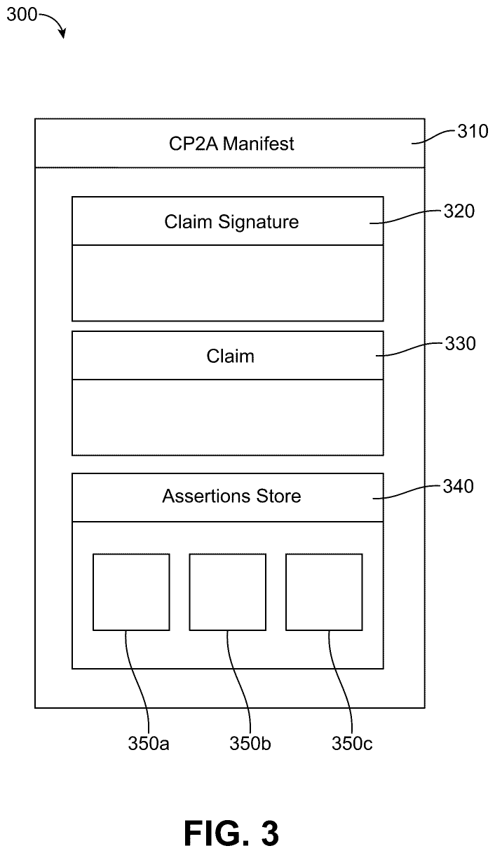

FIG. 3 shows an example of a manifest. In particular, FIG. 3 is a diagram illustrating an example 300 of a C2PA manifest 310 including its constituent parts. In FIG. 3, the manifest 310 is shown to include a claim signature 320, a claim 330, and an assertions store 340. The assertions store 340 is shown to include a plurality of assertions 350a, 350b, 350c. In one or more examples, the claim signature 320 may be in the form of a digital signature. In some examples, the assertion 350a may include a model of the camera used to capture the asset (e.g., which may be in the form of an image), the assertion 350b may include digital data (e.g., image data in the form of a Joint Photographic Experts Group (JPEG) file) of the asset, and the assertion 350c may include a hash of the digital data (e.g., image data) of the asset.

In one or more examples, for creation of the manifest 310, a user (e.g., an actor) may capture an image (e.g., a photograph) with their C2PA-enabled camera (or smartphone). Once the image is captured, the camera (or phone) can create a manifest 310 containing the assertions 350, 350b, 350c (e.g., that may include information about the camera, a thumbnail of the image, and some cryptographic hashes that bind the image to the manifest 310). The assertions 350, 350b, 350c can be listed in the claim 330, which can be digitally signed with a claim signature 320. The manifest 310 can then be embedded into an output JPEG file for the image. The manifest 310 may be valid indefinitely.

A manifest consumer, such as validator, can help users to establish the trustworthiness of the asset (e.g., an image) by first validating the digital signature (e.g., the claim signature 320) and its associated credential. The manifest consumer (e.g., validator) can also check each of the assertions 350, 350b, 350c for validity, and present the information contained in them, along with the digital signature, to the user in a way such that the user can then make an informed decision about the trustworthiness of the digital content of the asset.

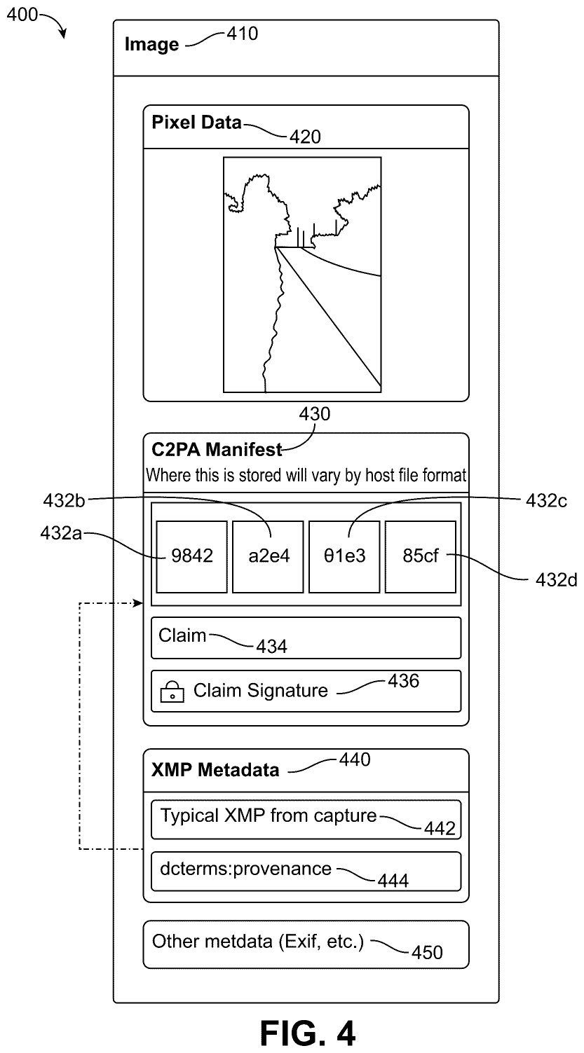

FIG. 4 shows an example representation of an asset in the form of an image. In particular, FIG. 4 is a diagram illustrating a visual representation 400 of an asset, in the form of an image 410, containing a single claim 434 with multiple assertions 432a, 432b, 432c, 432d that have been embedded inside of the image 410. In FIG. 4, the image 410 is shown to include pixel data 420 (e.g., including a thumbnail image), a manifest 430, metadata 440, and other metadata 450 (e.g., in an exchangeable image file format (Exif)). The manifest 430 is shown to include the multiple assertions 432a, 432b, 432c, 432d, the claim 434, and a claim signature 436. The metadata 440 (e.g., extensible metadata platform (XMP) metadata) is shown to include a typical XMP from capture 442 and provenance 444 for the image.

During operation for creation of the asset in the form of an image 410 of FIG. 4, the asset can be created (e.g., a camera can create the asset by capturing the pixel data 420 of the image 410). One or more processors can then create assertions 432a, 432b, 432c, 432d for the image 410. In one or more examples, the assertion 432a may include a thumbnail of the image 410, the assertion 432b may include a location (e.g., latitude and longitude) of where the image 410 was created, the assertion 432c may include a hash of the digital data of the image 410, and the assertion 432c may include the author that created the image.

In some examples, such as for assertion 432c, the one or more processors can calculate or compute hashes for one or more of the assertions. The assertions (or hashes of the assertions) can be stored within the manifest 430. The one or more processors can create a claim data structure (e.g., the claim 434), and store the claim data structure within the manifest 430. The one or more processors can sign the claim 434 to generate the claim signature 436, and store the claim signature 435 within the manifest 430.

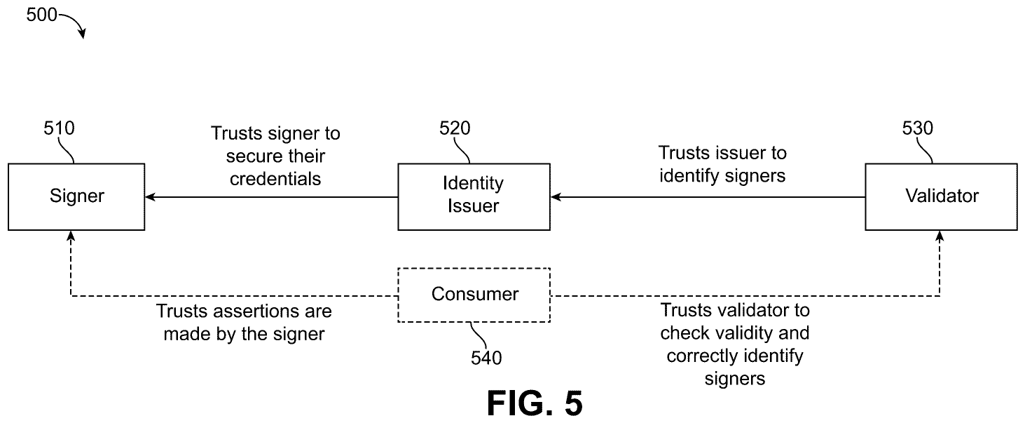

In one or more aspects, the basis of making trust decisions in C2PA (e.g., a trust model, such the trust model 500 in FIG. 5) is the identity of the actor associated with the cryptographic signing key used to sign a claim in an active manifest (e.g., active manifest 225 of FIG. 2). The identity of a signatory is not necessarily a human actor. The identity presented may be a pseudonym, completely anonymous, or pertain to a service or trusted hardware device with its own identity, including an application running inside such a service or trusted hardware. Manifests (e.g., manifests 220 of FIG. 2) may be validated indefinitely, regardless of whether the cryptographic credentials used to sign the manifests' contents are later expired or revoked.

FIG. 5 shows an example trust model concerned with trust in a signer's identity. In particular, FIG. 5 is a block diagram illustrating an example of a trust model 500 for establishing trust. In FIG. 5, the trust model 500 is shown to include three entities, which include a signer 510, an identity issuer 520, and a validator 530. The model 500 is also shown to include a consumer 540, who can use the identity of the signer 510, along with other trust signals, to decide whether assertions made about an asset (e.g., an image) are true.

In one or more examples, the signer 510 may be an actor (human or non-human) whose credential's private key is used to sign the claim. The signer 510 may be identified by the subject of the credential. The signer 510 should have valid credentials (e.g., mostly from a certification authority (CA)). A CA is an entity that stores, signs, and issues digital certificates, which certifies the ownership of a public key by the named subject of the certificate. The signer 510 should sign at each stage of asset modification (e.g., including creation, editing, etc.).

In some examples, the validator's 530 role is to perform actions associated with validation of an asset (e.g., an image). The validator 530 should read a manifest of an asset, and validate a signer 510 of the manifest. The validator 530 should notify information associated with the signer 510 to the consumer 540.

In one or more examples, the consumer 540 may be a consumer of the asset. The consumer 540 can check with the validator 530 to obtain information regarding the asset. Trust can be established (by the consumer 540) for an asset based on the credentials of the signer 510 and the assertions that the signer 510 is claiming.

During operation of the trust model 500 for establishing trust, the validator 530 can trust the identity issuer 520 to identity signers (e.g., including the signer 510) of a claim(s) associated with the asset. The identity issuer 520 can trust the signer 510 to secure the signer's credentials. The consumer 540 can trust the validator 530 to check the validity and correctly identify the signers (e.g., including the signer 510). The consumer 540 can also trust that assertions associated with the asset are made by the signer 510.

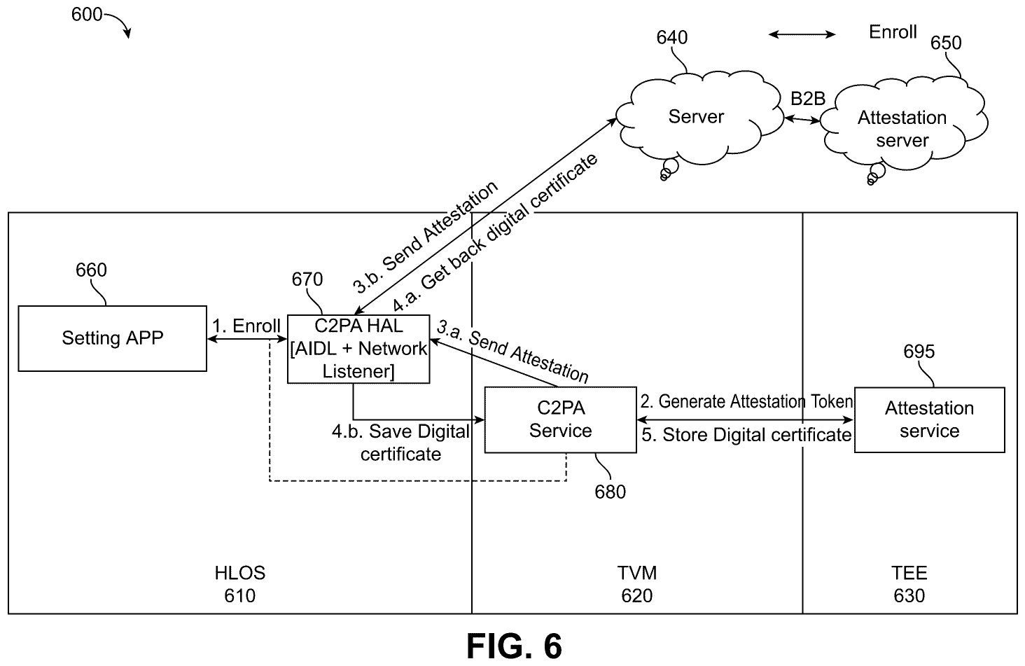

In one or more aspects, trust for a device may be established based on a signer's credentials. FIG. 6 is a functional block diagram illustrating an example of a process 600 for establishing trust for a device based on a signer's credentials. In FIG. 6, the functional block diagram is shown to include three sections, which include a high-level operating system (HLOS) 610, a trusted virtual machine (TVM) 620, and a trusted execution environment (TEE) 630. In one or more examples, the HLOS 610, the TVM 620, and the TEE 630 are all located on the device.

Trust for a device may be achieved through an attestation scheme. The process 600 of FIG. 6 is an attestation scheme for establishing trust for a device, where a private key (e.g., a hardware key) within the device (e.g., a smartphone), which generates and/or modifies an asset, is used to sign manifests. Each device has a hardware key (e.g., a private key) that is a random key (e.g., a chip random base key (CRBK)) that is unique and embedded within the hardware of the device.

During operation of the process 600 of FIG. 6, the device may be enrolled via a setting application 660. An attestation service 695 may generate an encrypted attestation token, which can include a public key and an attestation report. The public key (e.g., a software key) and the attestation report may be wrapped within the encrypted attestation token. The public key can correspond to the private key such that the public key (e.g., a software key) and the private key (e.g., a hardware key) form a public-private key pair, such as an asymmetric key pair (e.g., elliptic curve cryptography (ECC)). The attestation report can include information associated with device, such as the state the device is running, the model of the device, which original equipment manufacturer (OEM) manufactured the device, and the software running on the device.

The attestation service 695 may then send the encrypted attestation token to a C2PA service 680. The C2PA service 680 can then send the encrypted attestation token to a C2PA hardware abstraction layer (HAL) 670. The C2PA HAL 670 can then send the encrypted attestation token to a server 640 (e.g., a cloud server), which is a CA.

The encrypted attestation token can only be decrypted by an attestation server 650 (e.g., a cloud server, such as wireless edge services (WES)). The server 640 can then send the encrypted attestation token to the attestation server 650 for the attestation server 650 to decrypt the encrypted attestation token to produce a decrypted attestation token. The server 640 can then obtain, from the attestation sever 650, the public key and the attestation report from the decrypted attestation token.

Based on the information within the attestation report, the server 640 can then validate the attestation report and establish trust on the device. After the sever 640 has validated the attestation report, the server 640 can create (being a CA) a certificate (e.g., a digital certificate) for that public key that was issued from the device (e.g., the public key becomes the certificate). As such, the certificate can then be used by the device to sign a manifest, and the certificate can be included within the manifest itself such that anyone can verify the certificate. In order to verify the certificate, the public key is needed.

The server 640 can then send the certificate to the C2PA HAL 670. The C2PA HAL 670 can then send the certificate to the C2PA service 680. The C2PA service 680 can send the certificate to the attestation service 695 for the attestation service 695 to store the certificate in secure storage that the C2PA service 680 can call to. In some cases, the attestation service 695 can be in communication with a hardware key management service in a trusted management entity the device.

However, anyone can implement the C2PA specification and make a claim of assertions about the provenance of a media asset. Therefore, improved systems and techniques that provide higher level trust and assurances to the assertions regarding a media asset can be useful.

In one or more aspects, the CA (e.g., server 640 of FIG. 6) can establish trust for a device (e.g., as shown in FIG. 6). The CA can also make different levels of assurances (e.g., with low confidence and with high confidence) for different assertions. In one or more examples, different assertions may have different levels of trust.

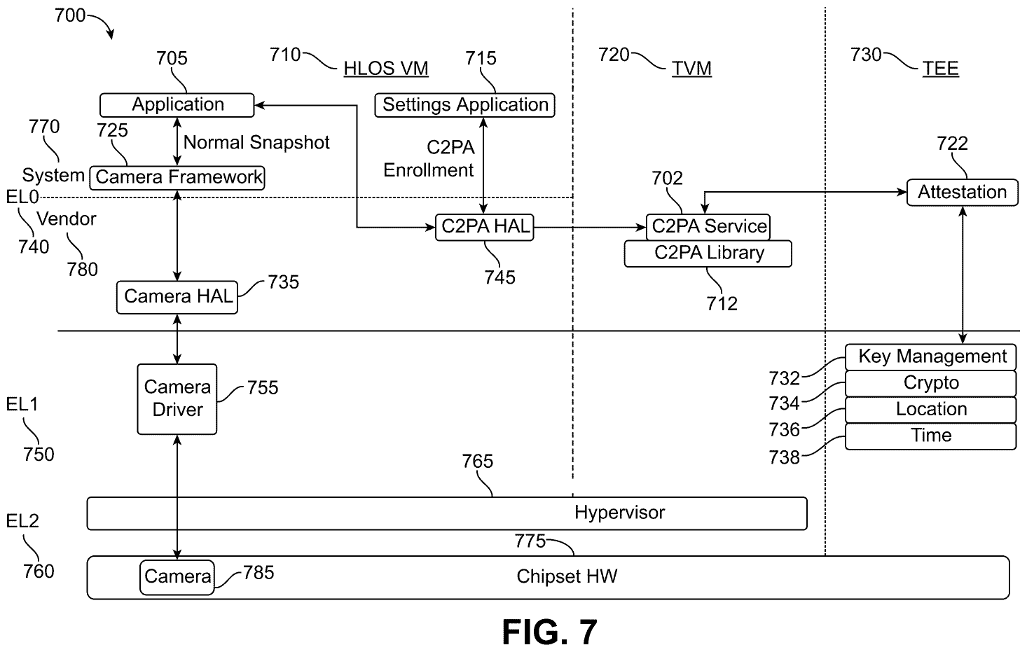

FIGS. 7, 8, and 9 provide solutions for providing higher level trust and assurances to the assertions regarding an asset (e.g., a media asset). In particular, FIG. 7 is a diagram illustrating an example of a process 700 for a first solution for providing higher level trust and assurances to the assertions regarding an asset. In FIG. 7, the diagram is shown to include three vertical sections, which include an HLOS virtual machine (VM) 710, a TVM 720, and a TEE 730. In one or more examples, the HLOS VM 710, the TVM 720, and the TEE 730 are all located on a device (e.g., a mobile device, such as a smartphone, smart watch, or tablet). The HLOS VM 710 is shown to include two horizontal sections, which include a system section 770 and a vendor section 780.

In one or more examples, the device may be located within a SOC. The SOC may run two operating systems (OSs), which can include a non-secure (NS) operating system and a secure operating system. There may be different execution levels at which code may be run on a given CPU. On the NS side (e.g., the NS operating system), the execution levels can include execution level (EL) 3 (e.g., the highest security level for the non-secure side), EL2 760 which is run by a hypervisor 765, EL1 750 which is run in the kernel, and EL0 740 which is run in the user space. On the secure side (e.g., the secure operating system), the execution levels can include secure execution level (SEL) 3, SEL2, SEL1, and SEL0. The TEE 730 is the secure operating system, which runs on SEL0 and SEL1. The HLOS VM 710 (e.g., is based in Linux) can run on EL1 (e.g., the Linux kernel) and EL0 (e.g., the user space).

In FIG. 7, the HLOS VM 710 is shown to include an application 705 (e.g., a pre-installed OEM application, such as an Android application), a camera framework 725, a camera HAL 735, a camera driver 755, a settings application 715, and a C2PA HAL 745.

The hypervisor 765 is shown to span across from the HLOS VM 710 to the TVM 720. The hypervisor 765 can manage multimedia systems. The hypervisor 765 can manage the address space of subsystems such that the application 705 (e.g., OEM Android application) cannot tamper with the subsystems. The chipset HW 755 is shown to span across the HLOS VM 710, the TVM 720, and the TEE 730.

In FIG. 7, the TVM 720 is shown to include a C2PA service 702 and a C2PA library 712. The TEE 730 is shown to include an attestation service 722. The attestation service 722 can perform key management 732 and cryptography 743. The attestation service 722 can also associate the location 736 and time 738 of creation of assets (e.g., images).

During operation of the process 700 of FIG. 7, the camera pipeline can run in the HLOS VM 710. The camera 785, which is in HLOS VM 710, can obtain an image (e.g., a snapshot). The image can then be post-processed (e.g., high dynamic range (HDR), denoising, compression, etc.) in the HLOS VM 710 to produce a JPEG file. After the image is post-processed, the JPEG file can then be sent to the application 705 (e.g., OEM Android application).

After receiving the JPEG file, the application 705 can send the JPEG file to the C2PA HAL 745. The C2PA HAL 745 can send the JPEG file to the C2PA service 702 within the TVM 720. The C2PA service 702 can include a manifest with a claim and assertions (e.g., including the location of capturing the image, the time of capturing the image, the type of sensor used to capture the image, etc.) within the JPEG file. The C2PA service 702 can then send the JPEG file (e.g., with the manifest) to the attestation service 722 in the TEE 730.

After receiving the JPEG file, the attestation service 722 can sign the claim in the manifest using a private key (e.g., a hardware key) of the device to create a claim signature in the manifest. The attestation service 722 can then send the signed JPEG file back to the C2PA service 702. After receiving the signed JPEG file, the C2PA service 702 can then attach a certificate (e.g., a public key) associated with the device, which may be stored within the C2PA library 712, to the manifest. The C2PA service 702 can assign an assurance level on each of the assertions accordingly (e.g., such that the different assertions may have different assurance levels). The C2PA service 702 can then send the resultant JPEG file (e.g., which includes a claim signature and a certificate) to the application 705 via the C2PA HAL 745. Anyone with a copy of the public key can then verify the resultant JPEG file.

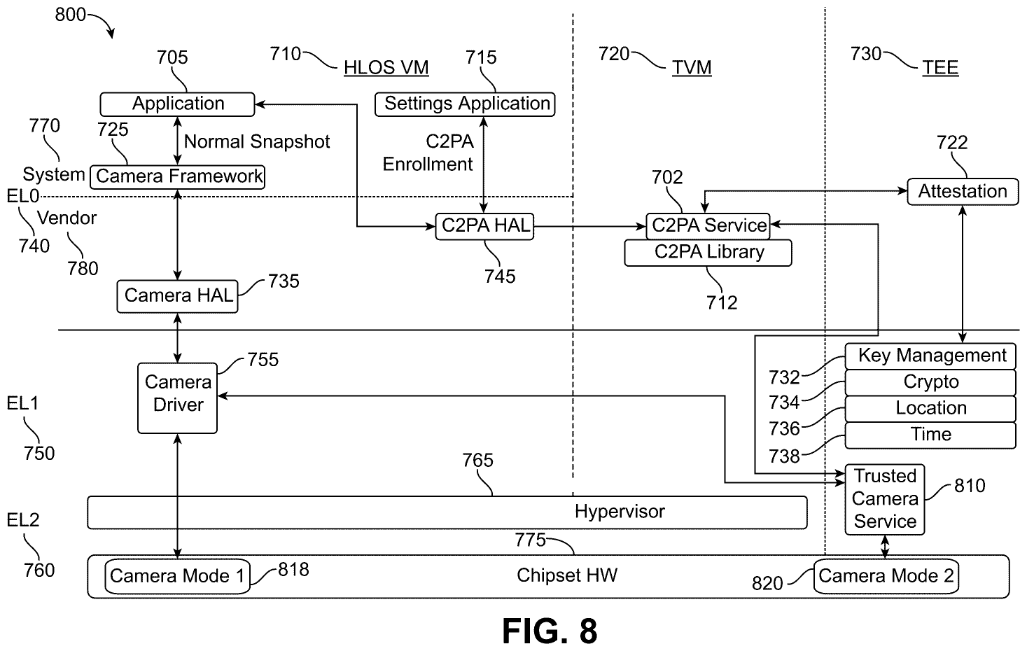

FIG. 8 is a diagram illustrating an example of a process 800 for a second solution for providing higher level trust and assurances to the assertions regarding an asset. FIG. 8 is similar to FIG. 7, except that the diagram of FIG. 8 includes a trusted camera service 810 and a camera 820 within the TEE 730. In one or more examples, to increase the assurance level of assertions, the assertions may be made within the TVM 720 without receiving instructions from the HLOS VM 710 to make the assertions. For assertions to be made within the TVM 720 without instruction from the HLOS VM 710, a secure camera pipeline is needed, where the HLOS VM 710 cannot access the raw image data.

During the process 800 of FIG. 8, the camera pipeline can run in the TEE 730 and the TVM 720. The camera 820, which is in TEE 730, can obtain an image (e.g., a snapshot). Since the post-processing of the image cannot occur within the HLOS VM 710 (e.g., as was done in the process 700 of FIG. 7), the image (e.g., the raw image data) may not be post-processed. The image file (e.g., including raw image data) can then be sent to the C2PA service 702 within the TVM 720.

After receiving the image file, the C2PA service 702 can include a manifest with a claim and assertions (e.g., including the location of capturing the image, the time of capturing the image, the type of sensor used to capture the image, etc.) within the image file. The C2PA service 702 can then send the image file (e.g., including the manifest with the claim and assertions) to the attestation service 722 in the TEE 730.

After receiving the image file, the attestation service 722 can sign the claim in the manifest using a private key (e.g., a hardware key) of the device to create a claim signature in the manifest. The attestation service 722 can send the signed image file back to the C2PA service 702. After receiving the signed image file, the C2PA service 702 can attach a certificate (e.g., a public key) associated with the device, which may be stored within the C2PA library 712, to the manifest. The C2PA service 702 can assign an assurance level on each of the assertions accordingly. The C2PA service 702 can then send the resultant image file (e.g., which includes a claim signature and a certificate) to the application 705 via the C2PA HAL 745.

In one or more aspects, the systems and techniques provide secure imaging for content provenance and authenticity, which can be used as a secure baseline for capturing images under a standard for content provenance and authenticity (e.g., a C2PA secure snapshot baseline). In one or more examples, the systems and techniques provide a secure baseline approach that allows for minimum disruption to a normal camera snapshot pipeline, while still achieving the desired security level by establishing a first manifest (e.g., an origin manifest) with a higher assurance claim provided by a TEE. For example, on a SOC, it can be assured that every image captured came from HW controlled by the TEE. The secure baseline approach also allows for KPIs of a snapshot for the user experience to be the same, while the background works on establishing the provenance for a secure image.

In one or more aspects, during operation of the systems and techniques for providing trust for an asset, a camera of a device may capture, operating in a secure mode, a first image of a scene. The camera of the device, operating in a non-secure (NS) mode, may capture a second image of the scene. One or more processors may generate, within a secure environment of the device based on the first image, a first manifest associated with the first image. One or more processors may process, within a non-secure environment of the device, the second image to produce a processed second image. One or more processors may generate, within the secure environment based on the processed second image, a second manifest associated with the processed second image. One or more processors can generate a media asset that includes the first manifest, the second manifest, and the processed second image.

In one or more examples, the first manifest may include a plurality of first assertions associated with the first image. In some examples, the plurality of first assertions may include a type of camera used to capture the first image, a location of where the first image was captured, and/or a time and day that the first image was captured. In one or more examples, the second manifest may include a plurality of second assertions associated with the processed second image. In some examples, the plurality of second assertions may include a type of editing used to process the second image to produce the processed second image and/or a time and day that the second image was processed to produce the processed second image.

In one or more examples, the type of editing may include filtering, denoising, compression, or high dynamic range (HDR). In some examples, the first image and the second image may be simultaneously captured. In one or more examples, the secure environment may include a trusted virtual machine (TVM) and/or a trusted execution environment (TEE). In some examples, the non-secure environment may include a high-level operating system (HLOS) virtual machine (VM). In one or more examples, the device may be a smartphone, a smart watch, or a tablet computer. In some examples, the asset may be in the form of an image.

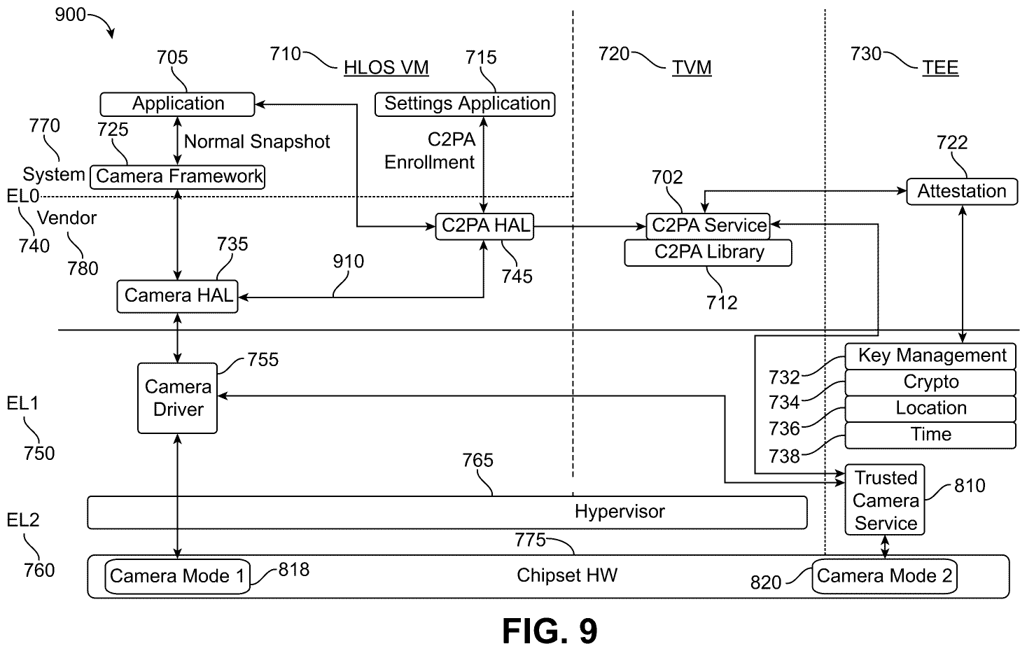

FIG. 9 is a diagram illustrating an example of a process 900 for a third solution (e.g., a disclosed solution) for providing higher level trust and assurances to the assertions regarding an asset. FIG. 9 is similar to FIG. 8, except that the diagram of FIG. 9 includes a connection 910 (e.g., a communications connection) directly between the camera HAL 735 and the C2PA HAL 745 within the HLOS VM 710. In one or more examples, the process 900 of FIG. 9 allows for an increase in the assurance level of the assertions, while maintaining a high image quality (e.g., achieved via post-processing of the raw image data).

During the process 900 of FIG. 9, the camera preview may be running such that a device is continuously capturing image frames of a scene. In one or more examples, the device may be a mobile device, such as a smartphone, a smart watch, or a tablet computer. When the user depresses the capture button on the device, the camera hardware can capture (e.g., simultaneously) two copies of the image of the scene. For example, the camera 785 (of FIG. 7) can operate in a first camera mode 818 (e.g., a non-secure mode) in the HLOS VM 710 and can operate in a second camera mode 820 (e.g., a secure mode) in the TEE 730. While operating in the second camera mode 820 (e.g., a secure mode), the camera can capture a first copy of the image, and while operating in the first camera mode 818 (e.g., a non-secure mode), the camera can capture a second copy of an image. As such, the first copy of the image (e.g., the first image) can be captured in a secure mode (e.g., by the camera 785 while operating in the second camera mode 820 in the TEE 730), and a second copy of the image (e.g., the second image) can be captured in a non-secure mode (e.g., by the camera 785 while operating in the first camera mode 818 in the HLOS VM 710).

In the secure mode, since the post-processing of the first image cannot occur within the HLOS VM 710, the first image (e.g., the raw image data) cannot be post-processed. The first image file (e.g., including raw image data) can be sent to the C2PA service 702 within the TVM 720. After receiving the first image file, the C2PA service 702 can include a manifest with a claim and assertions (e.g., including the location of capturing the image, the time of capturing the image, the type of sensor used to capture the image, etc.) within the first image file.

The C2PA service 702 can then send the first image file (e.g., including the manifest with the claim and assertions) to the attestation service 722 in the TEE 730. After receiving the first image file, the attestation service 722 can sign the claim in the manifest using a private key (e.g., a hardware key) of the device to create a claim signature in the manifest. The attestation service 722 can send the signed first image file back to the C2PA service 702. After receiving the signed first image file, the C2PA service 702 can attach a certificate (e.g., a public key) associated with the device, which may be stored within the C2PA library 712, to the manifest to produce a resultant first image file. The C2PA service 702 can assign an assurance level on each of the assertions accordingly.

In the non-secure mode, the camera pipeline can run in the HLOS VM 710. The second image can be post-processed (e.g., high dynamic range (HDR), denoising, compression, etc.) in the HLOS VM 710 to produce a JPEG file. After the second image is post-processed, the JPEG file can be sent to the application 705 (e.g., OEM Android application).

After receiving the JPEG file, the application 705 can send the JPEG file to the C2PA HAL 745. The C2PA HAL 745 can send the JPEG file to the C2PA service 702 within the TVM 720. The C2PA service 702 can include a manifest with a claim and assertions (e.g., including the location of capturing the image, the time of capturing the image, the type of sensor used to capture the image, etc.) within the JPEG file. In some cases, the assertions inside the manifest can come from the application 705 in the non-secure mode. The C2PA service 702 can send the JPEG file (e.g., with the manifest) to the attestation service 722 in the TEE 730.

After receiving the JPEG file, the attestation service 722 can sign the claim in the manifest using a private key (e.g., a hardware key) of the device to create a claim signature in the manifest. The attestation service 722 can then send the signed JPEG file back to the C2PA service 702. After receiving the signed JPEG file, the C2PA service 702 can then attach a certificate (e.g., a public key) associated with the device, which may be stored within the C2PA library 712, to the manifest to produce a resultant JPEG file. The C2PA service 702 can assign an assurance level on each of the assertions accordingly (e.g., such that the different assertions may have different assurance levels).

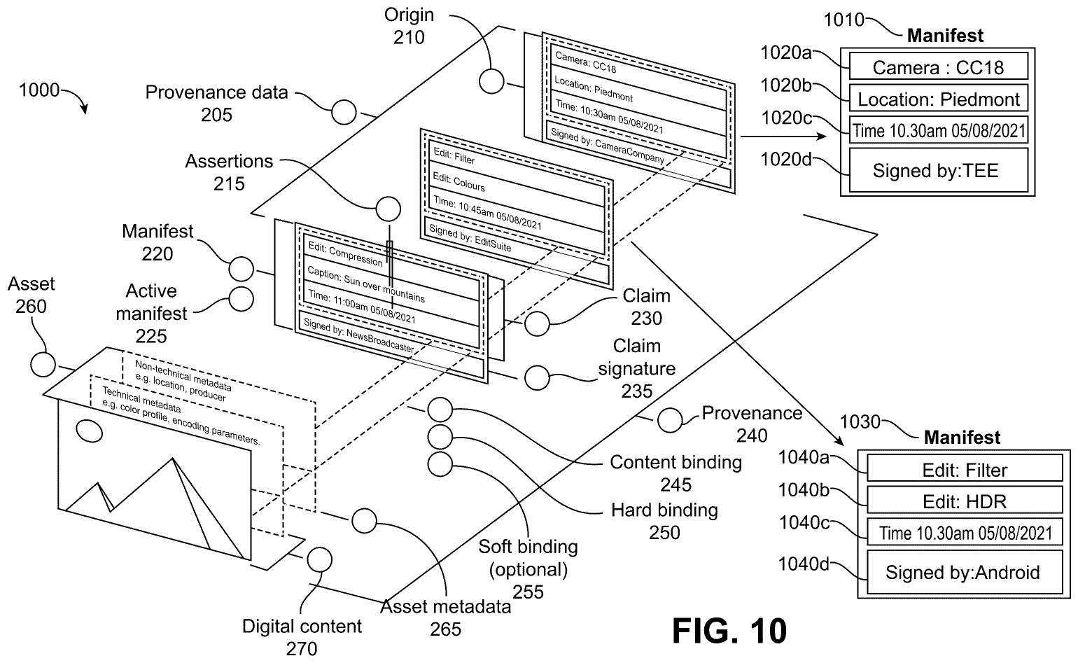

The C2PA service 702 can then associate (e.g., link together) the resultant JPEG file (e.g., which includes a claim signature and a certificate) with the resultant first image file (e.g., which includes a claim signature and a certificate). After the resultant JPEG file is associated (e.g., linked) with the resultant first image, the manifest from the resultant first image file can become the first manifest (e.g., an origin manifest, such as manifest 1010 of FIG. 10) for an asset, and the manifest from the resultant JPEG file can become a subsequent manifest (e.g., manifest 1030 of FIG. 10) for the same asset. For the asset, the first image (e.g., raw image data) can be discarded, and only the post-processed image data in the JPEG file can remain. The manifests (e.g., the origin manifest and the subsequent manifest) together in the asset can provide a history of the image.

FIG. 10 shows examples of an origin manifest (e.g., created from an image captured in a secure mode) and a subsequent manifest (e.g., created from an image captured in a non-secure mode). In particular, FIG. 10 is a diagram illustrating examples of elements of a C2PA architecture 1000, with examples of two created manifests 1010, 1030. FIG. 10 is similar to FIG. 2, except that FIG. 10 includes examples of manifests 1010, 1030 created from images captured in a secure mode and a non-secure mode, respectively.

In FIG. 10, an example of an origin manifest 210 (e.g., manifest 1010) created from an image captured in a secure mode is shown. The manifest 1010 is shown to include several assertions 1020a, 1020b, 1020c. The assertion 1020a is shown to include a model of the camera that was used to capture the image. The assertion 1020b is shown to include a location of where the image was captured. The assertion 1020c is shown to include a time and day that the image was captured. The manifest 1010 is also shown to include a claim signature 1020d, which indicates that the claim was signed by the TEE (e.g., TEE 730 of FIG. 9).

The manifest 1030 is shown to include several assertions 1040a, 1040b, 1040c. The assertion 1040a is shown to include a type of editing or post-processing (e.g., a filter) that was performed on the image. The assertion 1040b is shown to include a type of editing or post-processing (e.g., HRD) that was performed on the image. The assertion 1040c is shown to include a time and day that the image was edited. The manifest 1030 is also shown to include a claim signature 1040d, which indicates that the claim was signed by an Android application (e.g., application 705 of FIG. 9).

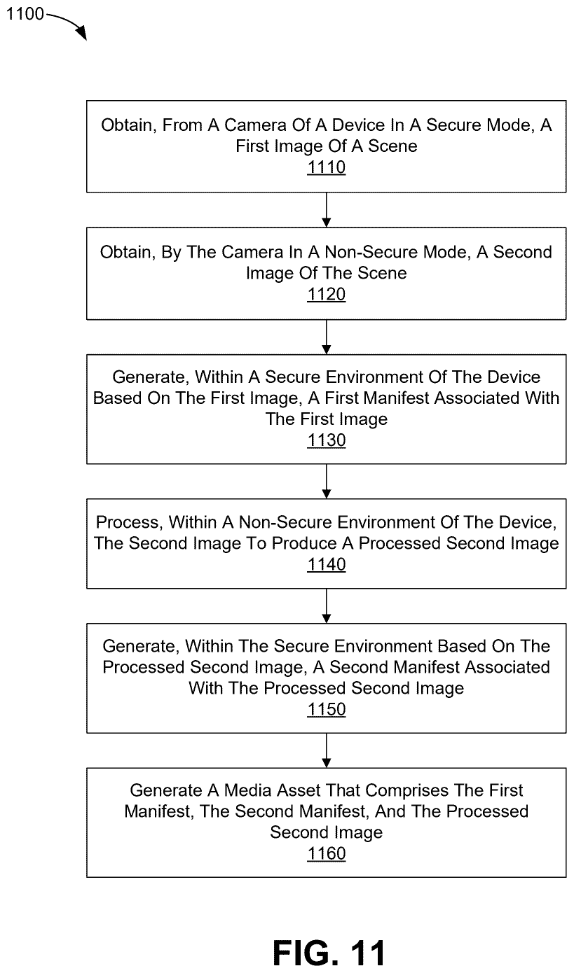

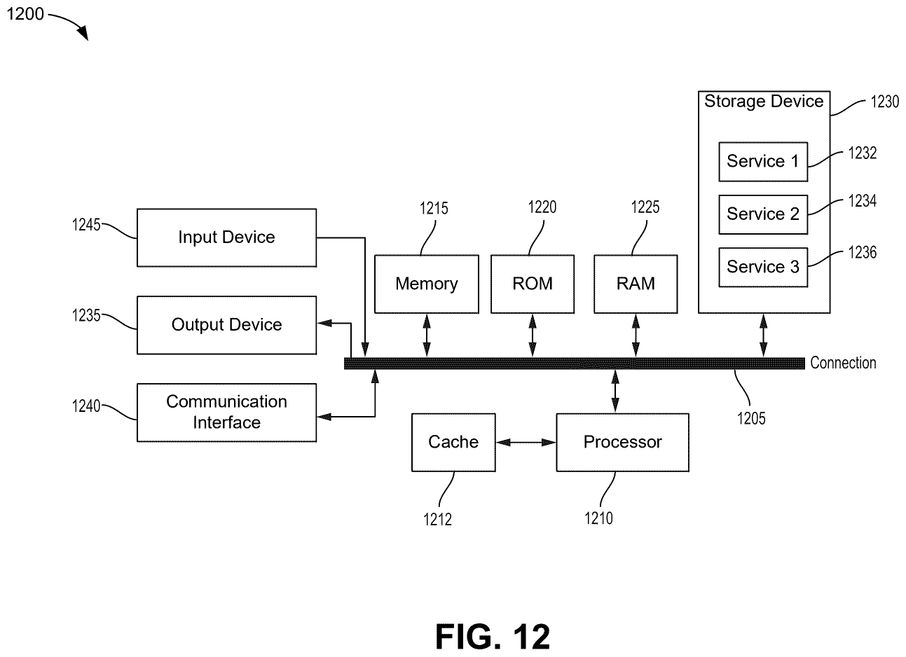

FIG. 11 is a flow chart illustrating an example of a process 1100 for providing secure imaging for content provenance and authenticity. The process 1100 can be performed by a computing device (e.g., computing device 100 of FIG. 1 and/or a computing device or computing system 1200 of FIG. 12) or by a component or system (e.g., a chipset such as the chipset hardware 775 of FIG. 7, FIG. 8, or FIG. 9, any other component of FIG. 7, FIG. 8, or FIG. 9, one or more processors central processing units (CPUs), digital signal processors (DSPs), graphics processing units (GPUs), any combination thereof, and/or other type of processor(s), or other component or system) of the computing device. The operations of the process 1100 may be implemented as software components that are executed and run on one or more processors (e.g., processor 110 of FIG. 1, processor 1210 of FIG. 12, or other processor(s)). Further, the transmission and reception of signals by the computing device in the process 1100 may be enabled, for example, by one or more antennas and/or one or more transceivers (e.g., wireless transceiver(s)).

At block 1110, the computing device (or component thereof) can obtain, from a camera of a device in a secure mode (e.g., camera mode 2 820 of FIG. 8 and/or FIG. 9), a first image of a scene. For example, the camera (while operating in the secure mode) can capture the first image of the scene.

At block 1120, the computing device (or component thereof) can obtain, from the camera of the device in a non-secure mode (e.g., camera mode 1 818 of FIG. 8 and/or FIG. 9), a second image of the scene. For example, the camera (while operating in the non-secure mode) can capture the second image of the scene. For instance, the first image and the second image can be simultaneously captured.

At block 1130, the computing device (or component thereof) can generate, within a secure environment of the device based on the first image, a first manifest associated with the first image. For instance, the secure environment can include a trusted virtual machine (TVM), a trusted execution environment (TEE), and/or other secure environment. In some aspects, the first manifest comprises a plurality of first assertions associated with the first image. In some cases, the plurality of first assertions include a type of camera used to capture the first image, a location of where the first image was captured, a time and day that the first image was captured, any combination thereof, and/or other assertions.

At block 1140, the computing device (or component thereof) can process, within a non-secure environment of the device, the second image to produce a processed second image. In some cases, the non-secure environment comprises a high-level operating system (HLOS) virtual machine (VM), and/or other secure environment.

At block 1150, the computing device (or component thereof) can generate, within the secure environment based on the processed second image, a second manifest associated with the processed second image. In some aspects, the second manifest comprises a plurality of second assertions associated with the processed second image. In some cases, the plurality of second assertions include a type of editing used to process the second image to produce the processed second image, a time and day that the second image was processed to produce the processed second image, and/or other assertions. In one illustrative example, the type of editing can include filtering, denoising, compression, high dynamic range (HDR), any combination thereof, and/or other types of editing.

At block 1160, the computing device (or component thereof) can generate a media asset (e.g., an image, a video, a text file, etc.) that includes the first manifest, the second manifest, and the processed second image.

In some cases, the computing device of process 1100 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1100 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1100 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1100 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a block diagram illustrating an example of a computing system 1200, which may be employed for a C2PA secure snapshot baseline. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200.

Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more range sensors (e.g., LiDAR sensors, laser range finders, RF radars, ultrasonic sensors, and infrared (IR) sensors) configured to collect data and provide measurements to processor 1210, whereby processor 1210 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for providing trust for assets, the apparatus comprising: at least one memory; and at least one processor coupled to the at least one memory and configured to: obtain, from a camera of a device in a secure mode, a first image of a scene; obtain, from the camera of the device in a non-secure mode, a second image of the scene; generate, within a secure environment of the device based on the first image, a first manifest associated with the first image; process, within a non-secure environment of the device, the second image to produce a processed second image; generate, within the secure environment based on the processed second image, a second manifest associated with the processed second image; and generate a media asset that comprises the first manifest, the second manifest, and the processed second image.

Aspect 2. The apparatus of Aspect 1, wherein the first manifest comprises a plurality of first assertions associated with the first image.

Aspect 3. The apparatus of Aspect 2, wherein the plurality of first assertions comprises at least one of a type of camera used to capture the first image, a location of where the first image was captured, or a time and day that the first image was captured.

Aspect 4. The apparatus of any of Aspects 1 to 3, wherein the second manifest comprises a plurality of second assertions associated with the processed second image.

Aspect 5. The apparatus of Aspect 4, wherein the plurality of second assertions comprises at least one of a type of editing used to process the second image to produce the processed second image or a time and day that the second image was processed to produce the processed second image.

Aspect 6. The apparatus of Aspect 5, wherein the type of editing comprises filtering, denoising, compression, or high dynamic range (HDR).

Aspect 7. The apparatus of any of Aspects 1 to 6, wherein the first image and the second image are simultaneously captured.

Aspect 8. The apparatus of any of Aspects 1 to 7, wherein the secure environment comprises at least one of a trusted virtual machine (TVM) or a trusted execution environment (TEE).

Aspect 9. The apparatus of any of Aspects 1 to 8, wherein the non-secure environment comprises a high-level operating system (HLOS) virtual machine (VM).

Aspect 10. The apparatus of any of Aspects 1 to 9, wherein the device is a smartphone, a smart watch, or a tablet computer.

Aspect 11. The apparatus of any of Aspects 1 to 11, wherein the media asset is an image.

Aspect 12. A method for providing trust for assets, the method comprising: capturing, by a camera of a device in a secure mode, a first image of a scene; capturing, by the camera of the device in a non-secure mode, a second image of the scene; generating, within a secure environment of the device based on the first image, a first manifest associated with the first image; processing, within a non-secure environment of the device, the second image to produce a processed second image; generating, within the secure environment based on the processed second image, a second manifest associated with the processed second image; and generating a media asset that comprises the first manifest, the second manifest, and the processed second image.

Aspect 13. The method of Aspect 12, wherein the first manifest comprises a plurality of first assertions associated with the first image.

Aspect 14. The method of Aspect 13, wherein the plurality of first assertions comprises at least one of a type of camera used to capture the first image, a location of where the first image was captured, or a time and day that the first image was captured.

Aspect 15. The method of any of Aspects 12 to 14, wherein the second manifest comprises a plurality of second assertions associated with the processed second image.

Aspect 16. The method of Aspect 15, wherein the plurality of second assertions comprises at least one of a type of editing used to process the second image to produce the processed second image or a time and day that the second image was processed to produce the processed second image.

Aspect 17. The method of Aspect 16, wherein the type of editing comprises filtering, denoising, compression, or high dynamic range (HDR).

Aspect 18. The method of any of Aspects 12 to 17, wherein the first image and the second image are simultaneously captured.

Aspect 19. The method of any of Aspects 12 to 18, wherein the secure environment comprises at least one of a trusted virtual machine (TVM) or a trusted execution environment (TEE).

Aspect 20. The method of any of Aspects 12 to 19, wherein the non-secure environment comprises a high-level operating system (HLOS) virtual machine (VM).

Aspect 21. A non-transitory computer-readable medium having stored thereon instructions that, when executed by at least one processor, cause the at least one processor to perform operations according to any of Aspects 12 to 20.

Aspect 22. An apparatus for providing trust for assets, the apparatus including one or more means for performing operations according to any of Aspects 12 to 20.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for providing trust for assets, the apparatus comprising:
at least one memory; and
at least one processor coupled to the at least one memory and configured to:
obtain, from a camera of a device in a secure mode, a first image of a scene;
obtain, from the camera of the device in a non-secure mode, a second image of the scene;
generate, within a secure environment of the device based on the first image, a first manifest associated with the first image;
process, within a non-secure environment of the device, the second image to produce a processed second image;
generate, within the secure environment based on the processed second image, a second manifest associated with the processed second image; and
generate a media asset that comprises the first manifest, the second manifest, and the processed second image.

2. The apparatus of claim 1, wherein the first manifest comprises a plurality of first assertions associated with the first image.

3. The apparatus of claim 2, wherein the plurality of first assertions comprises at least one of a type of camera used to capture the first image, a location of where the first image was captured, or a time and day that the first image was captured.

4. The apparatus of claim 1, wherein the second manifest comprises a plurality of second assertions associated with the processed second image.

5. The apparatus of claim 4, wherein the plurality of second assertions comprises at least one of a type of editing used to process the second image to produce the processed second image or a time and day that the second image was processed to produce the processed second image.

6. The apparatus of claim 5, wherein the type of editing comprises filtering, denoising, compression, or high dynamic range (HDR).

7. The apparatus of claim 1, wherein the first image and the second image are simultaneously captured.

8. The apparatus of claim 1, wherein the secure environment comprises at least one of a trusted virtual machine (TVM) or a trusted execution environment (TEE).

9. The apparatus of claim 1, wherein the non-secure environment comprises a high-level operating system (HLOS) virtual machine (VM).

10. The apparatus of claim 1, wherein the device is a smartphone, a smart watch, or a tablet computer.

11. The apparatus of claim 1, wherein the media asset is an image.

12. A method for providing trust for assets, the method comprising:
capturing, by a camera of a device in a secure mode, a first image of a scene;
capturing, by the camera of the device in a non-secure mode, a second image of the scene;
generating, within a secure environment of the device based on the first image, a first manifest associated with the first image;
processing, within a non-secure environment of the device, the second image to produce a processed second image;
generating, within the secure environment based on the processed second image, a second manifest associated with the processed second image; and
generating a media asset that comprises the first manifest, the second manifest, and the processed second image.

13. The method of claim 12, wherein the first manifest comprises a plurality of first assertions associated with the first image.

14. The method of claim 13, wherein the plurality of first assertions comprises at least one of a type of camera used to capture the first image, a location of where the first image was captured, or a time and day that the first image was captured.

15. The method of claim 12, wherein the second manifest comprises a plurality of second assertions associated with the processed second image.

16. The method of claim 15, wherein the plurality of second assertions comprises at least one of a type of editing used to process the second image to produce the processed second image or a time and day that the second image was processed to produce the processed second image.

17. The method of claim 16, wherein the type of editing comprises filtering, denoising, compression, or high dynamic range (HDR).

18. The method of claim 12, wherein the first image and the second image are simultaneously captured.

19. The method of claim 12, wherein the secure environment comprises at least one of a trusted virtual machine (TVM) or a trusted execution environment (TEE).

20. The method of claim 12, wherein the non-secure environment comprises a high-level operating system (HLOS) virtual machine (VM).
